(19) United States
(12) Patent Application Publication
(10) Pub. No.: US 2026/0321914 A1
(43) Pub. Date: Oct. 15, 2026

(54) ELECTRODE

(71) Applicant: TOYOTA JIDOSHA KABUSHIKI KAISHA, Toyota-shi (JP)

(72) Inventors: Kazuhito KATO, Toyota-shi (JP); Suguru Ikeyama, Toyota-shi (JP); Yasuhiro Sakashita, Nissin-shi (JP); Yosuke Shimura, Nagakute-shi (JP); Takahiko Nakano, Nagoya-shi (JP); Tomofumi Hirukawa, Miyoshi-shi (JP)

(73) Assignee: TOYOTA JIDOSHA KABUSHIKI KAISHA, Toyota-shi (JP)

(21) Appl. No.: 19/466,745

(22) Filed: Feb. 2, 2026

(30) Foreign Application Priority Data
Apr. 11, 2025 (JP) 2025-065691

(51) Int. Cl. H01M 50/538; H01M 4/70

(52) U.S. Cl. CPC H01M 50/538; H01M 4/70

(57) ABSTRACT

In an electrode in which an electrode active material layer is applied on at least one face of a current collector that is sheet-shaped, an uncoated portion of the current collector that is not coated with the electrode active material layer includes a plurality of current collector tabs that protrude in a direction away from a coated portion that is coated with the electrode active material layer, the current collector tabs are spaced apart from one another, in a direction in which the current collector tabs are arrayed, by notches extending in the direction in which the current collector tabs protrude, and one or more slits are fashioned in each of the current collector tabs.

### CROSS-REFERENCE TO RELATED APPLICATION

This application claims priority to Japanese Patent Application No. 2025-065691 filed on Apr. 11, 2025. The disclosure of the above-identified application, including the specification, drawings, and claims, is incorporated by reference herein in its entirety.

### BACKGROUND

### 1. Technical Field

The technology disclosed in the present specification relates to an electrode.

### 2. Description of Related Art

Japanese Unexamined Patent Application Publication No. 2014-22116 (JP 2014-22116 A) discloses an electrode plate for a secondary battery, which includes a current collector plate made of metal foil integrally equipped with current collector tabs and a current collector portion, and an active material layer formed on the current collector portion. The current collector tabs are divided into a plurality of current collector tab portions by slits extending in a direction away from the current collector portion.

### SUMMARY

An electrode in which an electrode active material layer is applied onto a face of a sheet-like current collector is pressed at a predetermined pressure using a roller, in order to increase density of the electrode active material layer and to make thickness thereof uniform. Difference in elongation occurs between a coated portion of the current collector where the electrode active material layer is applied and an uncoated portion where no electrode active material layer is applied, when pressed, and undulations or wrinkles (hereinafter, "undulations and so forth") occur in the uncoated portion due to the difference in elongation, which has been problematic. According to JP 2014-22116 A, slits are formed in order to suppress deformation of the current collector tab. However, the slits disclosed in JP 2014-22116 A alone are not sufficient to suppress the undulations and so forth that occur due to the aforementioned pressing.

In light of the foregoing issues, the present specification provides further improvements for suppressing the undulations and so forth that occur due to the aforementioned pressing.

The present specification discloses an electrode in which an electrode active material layer is applied on at least one face of a current collector that is sheet-shaped. According to the electrode, an uncoated portion of the current collector that is not coated with the electrode active material layer includes a plurality of current collector tabs that protrude in a direction away from a coated portion that is coated with the electrode active material layer. The current collector tabs are spaced apart from one another, in a direction in which the current collector tabs are arrayed, by notches extending in the direction in which the current collector tabs protrude, and one or more slits are fashioned in each of the current collector tabs.

According to the above configuration, the current collector tabs are spaced apart from each other by the notches, and further, each of the current collector tabs has one or more slits formed therein. Accordingly, the slits in each of the current collector tabs function to do away with undulations and so forth caused by the difference in elongation between the coated portion and the uncoated portion when the electrode is pressed. Thus, the occurrence of undulations and so forth caused by the above-described pressing is suppressed more than in conventional arrangements.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating, in a simplified manner, an electrode sheet to be roll-pressed, as viewed from a direction facing one face of the electrode sheet;

FIG. 2 is a diagram illustrating a portion of an electrode including an uncoated portion;

FIG. 3 is a diagram illustrating a portion of an electrode including an uncoated portion, which is an example that is different from that illustrated in FIG. 2;

FIG. 4 is a diagram illustrating an example of a portion of the electrode illustrated in FIG. 3 including cutting lines;

FIG. 5 is a cross-sectional view of a secondary battery; and

FIG. 6 is an exploded perspective view of an electrode stack.

### DETAILED DESCRIPTION OF EMBODIMENTS

The main features of an embodiment described below will first be described. These features can be combined optionally.

According to the electrode disclosed in the present specification, a shape of end portions of the notches opposite to distal ends of the current collector tabs may be a curved notched out shape.

According to the above configuration, the notches separating the current collector tabs from each other are formed by cutting out the end portions of the current collector tabs on the opposite side from the distal ends thereof in a curved shape. This further suppresses undulations and so forth from occurring in the current collector tabs. Also, damage to the end portions of the notches is suppressed.

According to the electrode disclosed in the present specification, the end portions may be notched out so as to be greater in width than a width of portions of the notches excluding the end portions.

This configuration further suppresses the occurrence of undulations and so forth in the current collector tabs. Also, damage to the end portions of the notches is suppressed.

According to the electrode disclosed in the present specification, the end portions may reach the coated portion.

This configuration further suppresses the occurrence of undulations and so forth in the current collector tabs.

According to the electrode disclosed in the present specification, among the current collector tabs, end current collector tabs that are situated at ends in the direction in which the current collector tabs are arrayed may include sides that are opposite to sides facing the current collector tabs that are adjacent to the end current collector tabs, and that are defined by end notches fashioned by notching out portions of the current collector, and corners of the end notches may be notched out to be shaped extending further into an inner side of the current collector.

According to this configuration, the occurrence of undulations and so forth in each of the current collecting tabs, including the end current collector tabs, is further suppressed. Also, damage to the end notches is suppressed.

An embodiment will be described with reference to the drawings. The drawings are merely exemplary, and the present embodiment is not limited to that which is illustrated in the drawings. Also, the drawings are exemplary, and accordingly a portion thereof may be omitted.

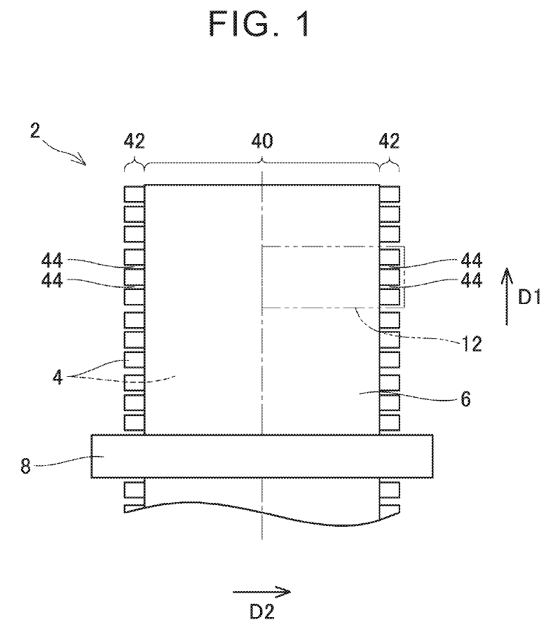

FIG. 1 illustrates, in a simplified manner, an electrode sheet 2 to be roll-pressed, as viewed from a direction facing one face of the electrode sheet 2. The electrode sheet 2 includes a current collector 4 in the form of an elongated sheet, and an electrode active material layer 6 applied onto at least one face of the current collector 4. The current collector 4 is a metal foil. A range of the current collector 4 in which the electrode active material layer 6 is applied will be referred to as "coated portion 40". A range of the current collector 4 in which the electrode active material layer 6 is not applied will be referred to as "uncoated portion 42". In FIG. 1, sign "D1" denotes a longitudinal direction D1 of the electrode sheet 2, and sign "D2" denotes a width direction D2 of the electrode sheet 2 that is perpendicular to the longitudinal direction D1. The electrode sheet 2 has the uncoated portions 42 each at one end and another end in the width direction D2.

According to FIG. 1, a roller 8 that is elongated in the width direction D2 comes into contact with the electrode sheet 2 as it is conveyed along the longitudinal direction D1. The electrode sheet 2 is roll-pressed under a predetermined pressure using the roller 8, in order to increase the density of the electrode active material layer 6 and to make thickness thereof uniform. A difference in elongation occurs between the coated portion 40 and the uncoated portions 42 during the pressing, and this difference in elongation causes undulations and so forth in the uncoated portions 42, which has been problematic.

In order to address this problem, notches 44 and slits 46 are formed in the uncoated portions 42 in the present embodiment. In FIG. 1, the notches 44 formed in the uncoated portions 42 are illustrated in a simplified manner. The slits 46 formed in the uncoated portions 42 are omitted from illustration in FIG. 1.

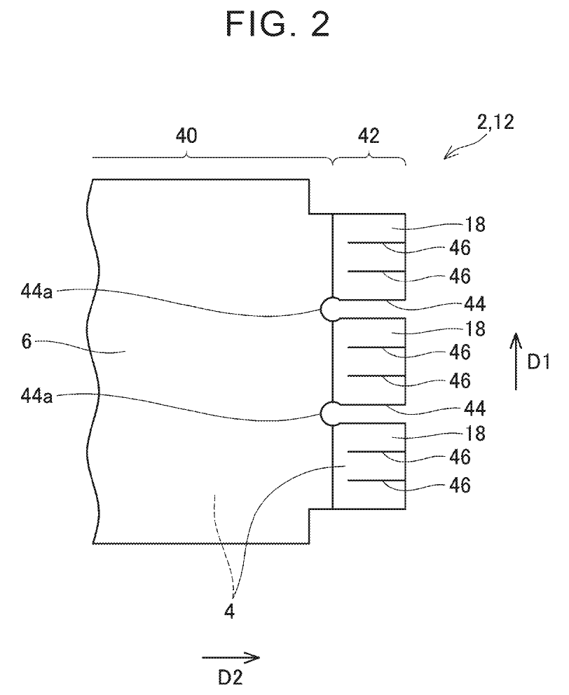

FIG. 2 illustrates primarily the uncoated portion 42 from the same perspective as in FIG. 1, but in greater detail than that in FIG. 1. The uncoated portion 42 includes a plurality of current collector tabs 18 that protrude in a direction away from the coated portion 40. In FIG. 2, the width direction D2 corresponds to a direction away from the coated portion 40 and the direction in which the current collector tabs 18 protrude. The current collector tabs 18 are formed spaced apart from one another in a direction in which the current collector tabs 18 are arrayed, by the notches 44 that extend in the direction in which the current collector tabs 18 protrude. In FIG. 2, the longitudinal direction D1 corresponds to the direction in which the current collector tabs 18 are arrayed. The notches 44 pass through the current collector 4, and are also open at ends of the current collector 4 in the direction away from the coated portion 40.

In FIG. 1, the size of one electrode 12 is exemplified by a region enclosed by a long dashed double-short dashed line. After the roll-pressing, the electrode sheet 2 is cut and separated into a plurality of the electrodes 12 each having, for example, the size illustrated in FIG. 1. Although FIG. 2 illustrates a portion of the electrode sheet 2 including the uncoated portion 42, this may be regarded as being a portion of a single electrode 12. That is to say, one electrode 12 has multiple current collector tabs 18. According to FIG. 2, the electrode 12 includes three current collector tabs 18. The number of the current collector tabs 18 provided on the electrode 12 may be two, or may be four or more.

Each of the current collector tabs 18 of the electrode 12 has one or more of the slits 46 formed therein. The slits 46 are cuts that pass through the current collector 4. According to FIG. 2, the slits 46 are open at the end of the current collector tab 18 in the direction away from the coated portion 40 (distal ends of current collector tabs 18 ). Also, according to FIG. 2, the direction in which the slits 46 extend is parallel or approximately parallel to the direction in which the notches 44 extend. Note, however, that at least one of the slits 46 formed in the current collector tabs 18 does not have to reach the distal ends of the current collector tabs 18, and may be inclined with respect to the direction in which the notches 44 extend.

According to FIG. 2, the notches 44 and the slits 46 have different shapes. The width (breadth) of the notches 44 is greater than the width (breadth) of the slits 46. The width of the notches 44 and the slits 46 means the width in a direction (direction D1 in FIG. 2) that is perpendicular to the direction in which these each extend (direction D2 in FIG. 2). For example, the slits 46 are linear cuts, whereas the notches 44 are wider than the slits 46, and clearly separate adjacent current collector tabs 18 from each other.

According to this configuration, the electrode 12 includes multiple current collector tabs 18. The current collector tabs 18 are spaced apart from each other by the notches 44, and moreover, each has one or more slits 46 formed therein. Accordingly, not only the notches 44 but also the slits 46 for each of the current collector tabs 18 function to reduce undulations and so forth in the uncoated portions 42 caused by difference in elongation between the coated portions 40 and the uncoated portions 42 when the electrodes 12 (electrode sheet 2 including the electrodes 12) are pressed. Specifically, the slits 46 for each of the current collector tabs 18 interrupts the propagation of undulations and so forth. Thus, the occurrence of undulations and so forth caused by the above-described pressing is suppressed more than in conventional arrangements.

As illustrated in FIG. 2, end portions 44a of the notches 44 opposite to the distal ends of the current collector tabs 18 may have curved cutout shapes. This further suppresses undulations and so forth from occurring in the current collector tabs 18. Also, damage to the end portions 44a is suppressed. As illustrated in FIG. 2, the end portions 44a have, for example, a circular shape (also referred to as semicircular shape, letter-C shape, and so forth). The end portions 44a may be oval or elliptical. Alternatively, the end portions 44a may be polygonal, rather than curved.

Furthermore, as illustrated in FIG. 2, the end portions 44a are notched out so as to have widths that are greater than those of the parts of the notches 44 excluding the end portions 44a. In other words, the width of the end portions 44a is greater than the width of the portions of the notches 44 excluding the end portions 44a. Such a configuration further suppresses the occurrence of undulations and so forth in the current collector tabs 18. Also, damage to the end portions 44a is suppressed. The present embodiment also includes a configuration in which the width of the end portions 44a is equal to or smaller than the width of the portions of the notches 44 excluding the end portions 44a. The slits 46 may also be notched out such that end portions opposite to the distal ends of the current collector tabs 18 have a width greater than the portions of the slits 46 excluding these end portions. The end portions of the slits 46 opposite to the distal ends of the current collector tabs 18 may be notched out in a curved shape, for example, similar to the end portions 44a of the notches 44.

Further, according to FIG. 2, the end portions 44a reach the coated portion 40. More specifically, the end portions 44a of the notches 44 are situated at boundaries between the coated portion 40 and the uncoated portions 42, and a portion of the end portions 44a extends into the coated portion 40. The slits 46 do not reach the coated portion 40. In this way, by completely severing direct connection among the current collector tabs 18 that are the uncoated portions 42, undulations and so forth can be further suppressed in the current collector tabs 18. The present embodiment also includes a configuration in which the end portions 44a do not reach the coated portion 40.

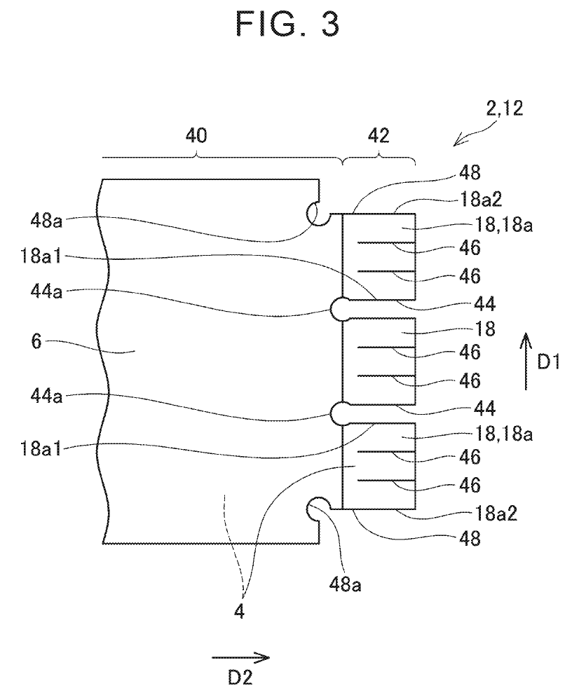

FIG. 3 primarily illustrates the uncoated portion 42, similar to FIG. 2. Of the multiple current collector tabs 18 that the electrode 12 has, end current collector tabs 18a that are situated at ends in the direction in which the current collector tabs 18 are arrayed have sides 18a2 that are opposite to sides 18a1 facing current collector tabs 18 that are adjacent thereto, and that are defined by end notches 48 formed by notching out portions of the current collector 4. The end notches 48 are formed by notching out corners of the electrode 12 over an area that is larger than that of the notches 44. According to FIG. 3, corners 48a of the end notches 48 are shaped having been notched out so as to extend further into the inner side of the current collector 4. More specifically, the corners 48a extend into the inner side of the coated portion 40 and have curved (e.g., circular) notched shapes, similar to the end portions 44a described above. According to such a configuration, in the electrode 12, undulations and so forth are further suppressed from occurring in each of the multiple current collector tabs 18, including the end current collector tabs 18a. Also, the corners 48a of the end notches 48 are shaped having been notched out so as to extend further into the inner side of the current collector 4, and accordingly damage of the end notches 48 is suppressed.

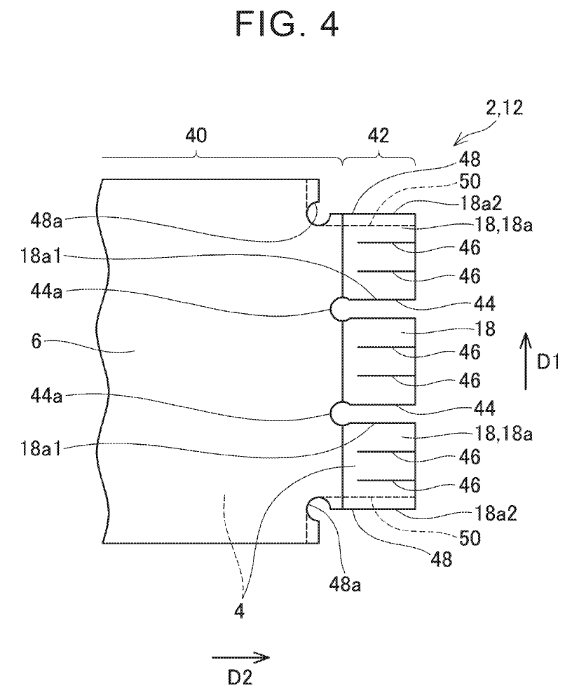

FIG. 4 illustrates the uncoated portion 42 having the same shape as that in FIG. 3. After the electrode 12 (electrode sheet 2 including electrode 12) with the notches 44 (and edge notches 48) and the slits 46 formed therein in advance as described above is roll-pressed, the electrode 12 may be further cut in the vicinity of the end notches 48. FIG. 4 shows cutting lines 50 along the end notches 48, on the inner side of the current collector 4. That is to say, after the roll pressing, the current collector 4 may be cut along the cutting lines 50 to further enlarge the end notches 48. By cutting the current collector 4 along the cutting lines 50, a portion of the end current collector tabs 18a and a portion of the coated portion 40 near the corners 48a are cut away. As a result, undulations and so forth that occur near the end notches 48 after roll pressing can be done away with. After cutting along the cutting lines 50, the end notches 48 do not have the shapes of the corners 48a such as illustrated in FIGS. 3, 4. According to the present embodiment, a manufacturing method of an electrode is disclosed, which includes a process of cutting a portion of the current collector 4 along such cutting lines 50.

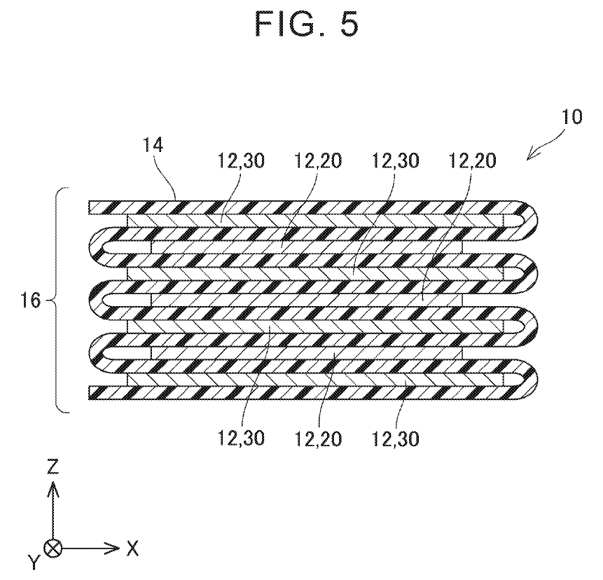

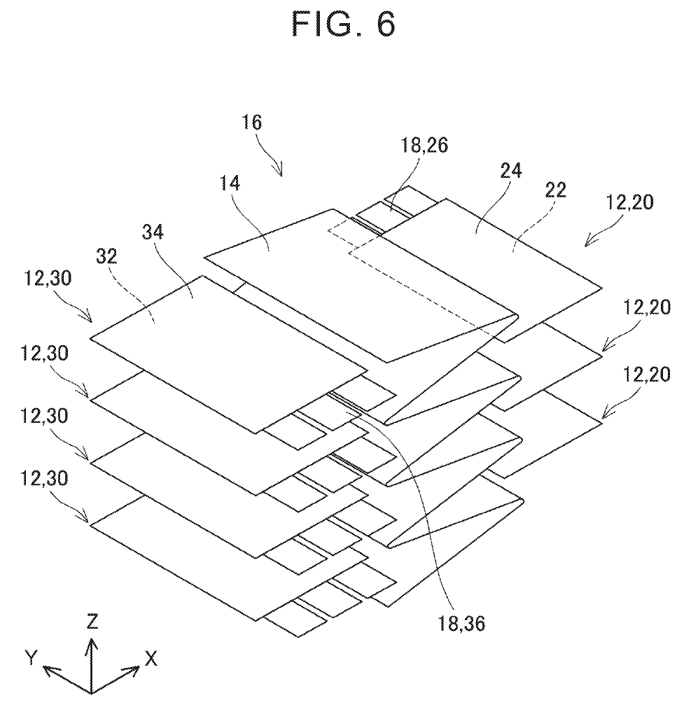

The electrode 12 is used as part of a configuration of a secondary battery 10, for example, as illustrated in FIGS. 5 and 6. FIG. 5 illustrates, in a simplified manner, a cross-section of the secondary battery 10. The secondary battery 10 may be, for example, a lithium-ion battery that is capable of being charged and discharged. The secondary battery 10 includes an electrode stack 16 formed by stacking the electrodes 12 in a first direction with separators 14 interposed therebetween. FIG. 6 is an exploded perspective view illustrating, in a simplified manner, the electrode stack 16. The electrodes 12 include cathodes 20 and anodes 30.

The secondary battery 10 includes an outer encasement, omitted from illustration, that is flexible, and the electrode stack 16 is sealed inside the outer encasement. An electrolytic solution, omitted from illustration, is sealed inside the outer encasement. The outer encasement is, for example, a laminate sheet. For convenience of description, X, Y, and Z axes that are perpendicular to one another are shown in FIGS. 5, 6. A Z-axis direction corresponds to the first direction. The first direction may be referred to as "stacking direction". FIG. 5 is a cross-sectional view taken along a plane perpendicular to the Y axis.

As illustrated in FIGS. 5, 6, the electrode stack 16 is formed by alternately stacking substantially rectangular cathodes 20 and substantially rectangular anodes 30 such that the separator 14 that is strip-shaped and is folded repeatedly in accordion fashion with alternating mountain and valley folds is interposed therebetween. The state in this case is a state in which each of a plurality of the cathodes 20 is clamped by one face of both faces of the separator 14, while each of a plurality of the anodes 30 is clamped by another face of both faces of the separator 14. The cathodes 20 and the anodes 30 each extend in an X-axis direction and a Y-axis direction. With respect to the electrode 12, the Y-axis direction may be understood to correspond to the direction D2 in FIGS. 1 to 4.

The separator 14 is formed of a material that provides both permeability that enables movement of charge carriers (lithium ions here) during charging and discharging, and insulation that suppresses short-circuiting caused by contact between the cathodes 20 and the anodes 30. Examples of materials for the separator 14 include polypropylene, polyethylene, and so forth. The configuration in which a continuous separator 14, folded in accordion fashion, is interposed between the electrodes 12 as illustrated in FIGS. 5, 6 is merely an example. The separators 14 interposed between the electrodes 12 may be separate from each other. In any case, the electrode stack 16 is formed by alternately stacking the cathodes 20 and the anodes 30 in the first direction with the separator 14 interposed therebetween.

As illustrated in FIG. 6, the cathodes 20 include cathode current collectors 22 and cathode active material layers 24 applied onto the cathode current collectors 22. The cathode current collectors 22 correspond to an example of the current collector 4, and the cathode active material layers 24 correspond to an example of the electrode active material layer 6. The cathode active material layers 24 are applied, for example, on both faces of the cathode current collectors 22. The cathode current collectors 22 are, for example, aluminum foil. The cathode active material layers 24 contain a cathode active material. Examples of cathode active materials include lithium nickel composite oxides, lithium cobalt composite oxides, lithium manganese composite oxides, and so forth.

The anodes 30 include anode current collectors 32 and anode active material layers 34 applied onto the anode current collectors 32. The anode current collectors 32 correspond to an example of the current collector 4, and the anode active material layers 34 correspond to an example of the electrode active material layer 6. The anode active material layers 34 are applied, for example, on both faces of the anode current collectors 32. The anode current collectors 32 are, for example, copper foil. The anode active material layers 34 contain an anode active material. Examples of anode active materials include carbon materials such as graphite, hard carbon, soft carbon, and so forth, materials that form alloys with lithium, such as silicon (Si) and so forth, and lithium alloys and so forth. The electrode active material may be made of a single type of material or may be made of a plurality of types of materials. The electrode active material layer may also contain a conductive aid, a binder, and so forth.

Each of the electrodes 12 (cathodes 20, anodes 30) includes current collector tabs 18 protruding in a second direction intersecting the first direction. Here, the Y-axis direction (positive Y-axis direction and negative Y-axis direction) corresponds to the second direction. According to FIG. 6, the current collector tabs 18 formed by the uncoated portions 42 of the cathodes 20 protrude in the positive direction of the Y axis. The current collector tabs 18 of the cathodes 20 correspond to a plurality of cathode current collector tabs 26. Also, according to FIG. 6, the current collector tabs 18 formed by the uncoated portions 42 of the anodes 30 protrude in the negative direction of the Y axis. The current collector tabs 18 of the anodes 30 correspond to a plurality of anode current collector tabs 36. The cathode current collector tabs 26 and the anode current collector tabs 36 each protrude in opposite directions from each other and also extend outward beyond the range clamped between the separator 14. The respective cathode current collector tabs 26 of the cathodes 20 are electrically connected to a cathode terminal that is omitted from illustration. The respective anode current collector tabs 36 of the anodes 30 are electrically connected to an anode terminal that is omitted from illustration. The features of the electrodes 12, including the current collector tabs 18, described with reference to FIGS. 1 to 4, are applicable to both the cathodes 20, including the cathode current collector tabs 26, and the anodes 30, including the anode current collector tabs 36.

Although specific examples of the technology disclosed in the present specification have been described in detail above, these are merely exemplary and do not limit the scope of the claims. The technology described in the claims includes various modifications and variations of the specific examples exemplified above. Also, the technical elements described in the present specification and the drawings exhibit technical utility either individually or in various combinations, and are not limited to the combinations described in the claims as originally filed. Also, the technology exemplified in the present specification and the drawings achieve multiple objectives simultaneously, and achieving even one of these objectives alone provides technical utility.

What is claimed is:

1. An electrode in which an electrode active material layer is applied on at least one face of a current collector that is sheet-shaped, wherein
an uncoated portion of the current collector that is not coated with the electrode active material layer includes a plurality of current collector tabs that protrude in a direction away from a coated portion that is coated with the electrode active material layer,
the current collector tabs are spaced apart from one another, in a direction in which the current collector tabs are arrayed, by notches extending in the direction in which the current collector tabs protrude, and
one or more slits are fashioned in each of the current collector tabs.

2. The electrode according to claim 1, wherein a shape of end portions of the notches opposite to distal ends of the current collector tabs is a curved notched out shape.

3. The electrode according to claim 2, wherein the end portions are notched out so as to be greater in width than a width of portions of the notches excluding the end portions.

4. The electrode according to claim 2, wherein the end portions reach the coated portion.

5. The electrode according to claim 1, wherein,
among the current collector tabs, end current collector tabs that are situated at ends in the direction in which the current collector tabs are arrayed include sides that are opposite to sides facing the current collector tabs that are adjacent to the end current collector tabs, and that are defined by end notches fashioned by notching out portions of the current collector, and
corners of the end notches are notched out to be shaped extending further into an inner side of the current collector.
